(19) United States
(12) Patent Application Publication
(10) Pub. No.: US 2004/0264256 A1
(43) Pub. Date: Dec. 30, 2004

(54) Electrical solution to enable high-speed interfaces

(76) Inventors: Karl H. Mauritz, Chandler, AZ (US); David W. Frame, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/609,216

(22) Filed: Jun. 26, 2003

(51) Int. Cl. G06F 12/00

(52) U.S. Cl. 365/189.01; 365/52; 711/100; 714/733

(57) ABSTRACT

According to one embodiment of the present invention, a circuit is disclosed. The circuit includes: a plurality of memory modules; a memory controller coupled to the plurality of memory modules; a plurality of bus splitters coupled between the plurality of memory modules and the memory controller to split signals communicated between the plurality of memory modules and the memory controller; and a plurality of terminators to reduce signal reflections corresponding to the split signals.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention generally relates to the field of electronic data transmission. More particularly, an embodiment of the present invention relates to electrical solution to enable high-speed memory interfaces to 1 GHz.

### BACKGROUND

As computers become more commonplace in everyday life, it is becoming more important to have higher overall system performance. This is especially true when the system performance is shared amongst users (such as in a client-server environment). In today's computer systems, memory performance is critical to realizing overall system performance. Generally, processor and input/output (I/O) performance needs are exceeding the memory bandwidth and density capability of available technologies. In order to push the speed of double data rate (DDR) or synchronous dynamic random access memory (SDRAM) memory interfaces, higher signal integrity is requiring memory size to be sacrificed.

For example, while faster memories such as DDR333 may increase speed when compared with older memories such as DDR200, DDR333 may decrease memory size significantly for reliability purposes. Moreover, the present solutions tend to be very sensitive to relatively slight variations in silicon, printed circuit board (PCB), design, and clock jitter, in part, because they generally act as tuned resonance structures.

Furthermore, dual in-line memory modules (DIMMs) are generally routed in parallel (i.e., with one signal visiting each DIMM). As the signal travels from chipset to DIMM then to another DIMM, each DIMM represents an electrical discontinuity (or impedance discontinuity), which degrades the signal, in part, because a portion of the wave reflects back to the chipset (also called a reflection) and another portion is passed to the next DIMM.

The signal reflection problem is further exasperated in multiple DIMM configurations because each DIMM may generate an additional reflection for each signal line it shares with other DIMMs. Also, as the data rates increase, the detrimental affects become increasingly difficult to manage.

### BRIEF DESCRIPTION OF THE DRAWINGS

The invention is illustrated by way of example and not limitation in the figures of the accompanying drawings, in which like references indicate similar or identical elements, and in which:

FIG. 1 illustrates an exemplary block diagram of a computer system 100 in accordance with an embodiment of the present invention;

FIG. 2 illustrates an exemplary block diagram of a four-way splitter 200 in accordance with an embodiment of the present invention;

FIG. 3 illustrates an exemplary graph 300 for splitter number versus voltage at receiver for various sample impedance values in accordance with an embodiment of the present invention;

FIG. 4 illustrates an exemplary one-deep memory expander chip interconnect configuration 400 in accordance with an embodiment of the present invention; and

FIG. 5 illustrates an exemplary two-deep memory expander chip interconnect configuration 500 in accordance with an embodiment of the present invention.

### DETAILED DESCRIPTION

In the following detailed description of the present invention numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

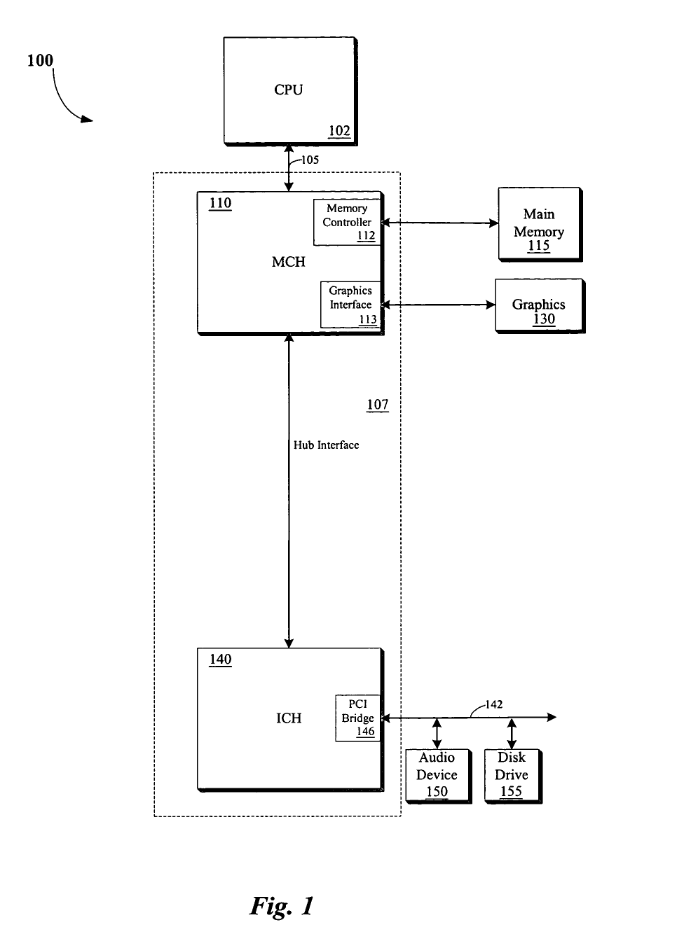

FIG. 1 illustrates an exemplary block diagram of a computer system 100 in accordance with an embodiment of the present invention. The computer system 100 includes a central processing unit (CPU) 102 coupled to a bus 105. In one embodiment, the CPU 102 is a processor in the Pentium® family of processors including the Pentium® II processor family, Pentium® III processors, Pentium® IV processors available from Intel Corporation of Santa Clara, Calif. Alternatively, other CPUs may be used, such as Intel's XScale processor, Intel's Banias Processors, ARM processors available from ARM Ltd. of Cambridge, the United Kingdom, or OMAP processor (an enhanced ARM-based processor) available from Texas Instruments, Inc., of Dallas, Tex.

A chipset 107 is also coupled to the bus 105. The chipset 107 includes a memory control hub (MCH) 110. The MCH 110 may include a memory controller 112 that is coupled to a main system memory 115. Main system memory 115 stores data and sequences of instructions that are executed by the CPU 102 or any other device included in the system 100. In one embodiment, main system memory 115 includes dynamic random access memory (DRAM); however, main system memory 115 may be implemented using other memory types. Additional devices may also be coupled to the bus 105, such as multiple CPUs and/or multiple system memories.

The MCH 110 may also include a graphics interface 113 coupled to a graphics accelerator 130. In one embodiment, graphics interface 113 is coupled to graphics accelerator 130 via an accelerated graphics port (AGP) that operates according to an AGP Specification Revision 2.0 interface developed by Intel Corporation of Santa Clara, Calif. In an embodiment of the present invention, a flat panel display may be coupled to the graphics interface 113 through, for example, a signal converter that translates a digital representation of an image stored in a storage device such as video memory or system memory into display signals that are interpreted and displayed by the flat-panel screen. It is envisioned that the display signals produced by the display device may pass through various control devices before being interpreted by and subsequently displayed on the flat-panel display monitor.

In addition, the hub interface couples the MCH 110 to an input/output control hub (ICH) 140 via a hub interface. The ICH 140 provides an interface to input/output (I/O) devices within the computer system 100. The ICH 140 may be coupled to a Peripheral Component Interconnect (PCI) bus adhering to a Specification Revision 2.1 bus developed by the PCI Special Interest Group of Portland, Oreg. Thus, the ICH 140 includes a PCI bridge 146 that provides an interface to a PCI bus 142. The PCI bridge 146 provides a data path between the CPU 102 and peripheral devices.

The PCI bus 142 includes an audio device 150 and a disk drive 155. However, one of ordinary skill in the art will appreciate that other devices may be coupled to the PCI bus 142. In addition, one of ordinary skill in the art will recognize that the CPU 102 and MCH 110 could be combined to form a single chip. Furthermore, graphics accelerator 130 may be included within MCH 110 in other embodiments.

In addition, other peripherals may also be coupled to the ICH 140 in various embodiments. For example, such peripherals may include integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Moreover, the computer system 100 is envisioned to receive electrical power from one or more of the following sources for its operation: a battery, alternating current (AC) outlet (e.g., through a transformer and/or adaptor), automotive power supplies, airplane power supplies, and the like.

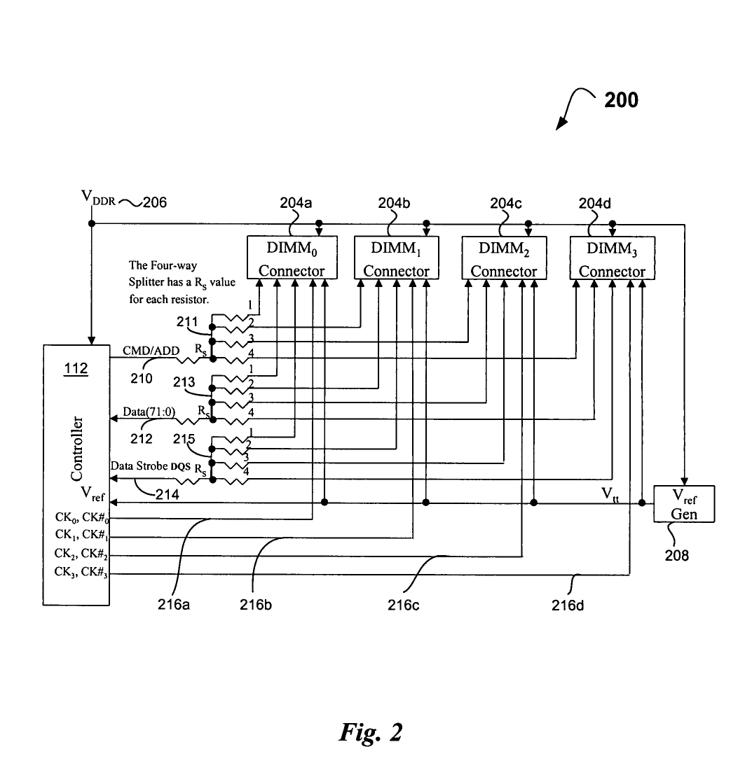

FIG. 2 illustrates an exemplary block diagram of a four-way splitter 200 in accordance with an embodiment of the present invention. The splitter 200 includes the memory controller 112 (such as that discussed with reference to FIG. 1). The splitter 200 further includes one or more DIMMs (204a-d) and a reference voltage generator (208). The memory controller 112 provides command/address signals (210) (e.g., through a bus splitter 211) to the DIMMs (204a-d). In turn, the DIMMs (204a-d) provide data signals (212) (e.g., through a bus splitter 213) and data strobe signal (214) (e.g., through a bus splitter 215) to the memory controller 112. The DIMMs (204a-d) further receive clock signals (216a-d) from the memory controller 112. The reference voltage generator (208) utilizes a memory chip voltage (206) to generate a reference voltage (Vtt), which is in turn provided to the DIMMs (204a-d) and the memory controller 112. In an embodiment of the present invention, each individual Data/command/Address/Strobe line from the controller has a splitter. Each output from the splitter may be a continuation to a DIMM or MXC line.

In various embodiments of the present invention, the characteristics of the splitter 200 may be summarized as follows:

Rs=((n−1)*Zo)/(n+1), where n=the number of splitter segments (where n=4 for the embodiment of the present invention shown in FIG. 2 (i.e., one driver input with four (n) receiver outputs));

Voltage to DIMMs=V*Zo/((n+1)(Rs+Zo)), where V=initial minimum driver voltage and N=n-way splitter;

Zo=transmission line impedance (e.g., 55 Ω+/−10%); and

Vtt=VDDR/2, if Vtt=3.3V then Vref=2.5V+/−5% with a minimum of about 2.375 V and maximum of about 2.625 V (i.e., the drive output should have low output drive resistance for higher output voltage swing).

With respect to the example above, it is envisioned that other Zo, Vtt, or VDDR values may be used. In a further embodiment of the present invention, the data and/or the data strobe signals (210 and 212, respectively) are internally terminated in the memory controller 112 during reads. In another embodiment of the present invention, during writes the terminations are disabled for higher output voltage capability. In yet another embodiment of the present invention, the DIMMs are terminated so that they do not generate reflections. Once the DIMMs are required to drive their signals, they may open their termination to increase signal amplitude in accordance with an embodiment of the present invention.

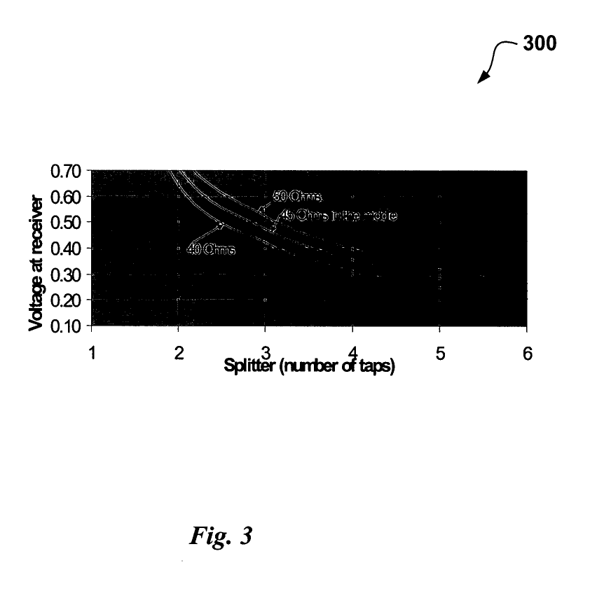

FIG. 3 illustrates an exemplary graph 300 for splitter number versus voltage at receiver for various sample impedance values in accordance with an embodiment of the present invention. In an embodiment of the present invention, the graph 300 illustrates that other splitter configurations are possible with two to six from a single driving point. Since the graph 300 is exemplary, it is envisioned that other splitter configurations with different tap numbers may be utilized.

In one embodiment of the present invention, the graph 300 illustrates the results for a driver with an output impedance of 30 Ohms, driving into a minimum 40-Ohm transmission line and a maximum of 50 Ohms with a nominal value if 45 Ohms. To accomplish these characteristics, the sensitivity of the receivers may be increased to 0.1 V or 0.05 V peak to peak for both DDR memories and the memory controller 112 in accordance with an embodiment of the present invention. Additionally, the noise floor may be lowered. Lower voltages on newer technology are generally related to decreased drive voltage, increased receiver sensitivity, and decreased noise floor. The graph further illustrates an n-way splitter from two to six tabs at a minimum VDDR of about 2.375 V in one embodiment of the present invention. Also, the graph 300 indicates 310 mV for a 40-Ohm Ron in a four-way splitter embodiment of the present invention.

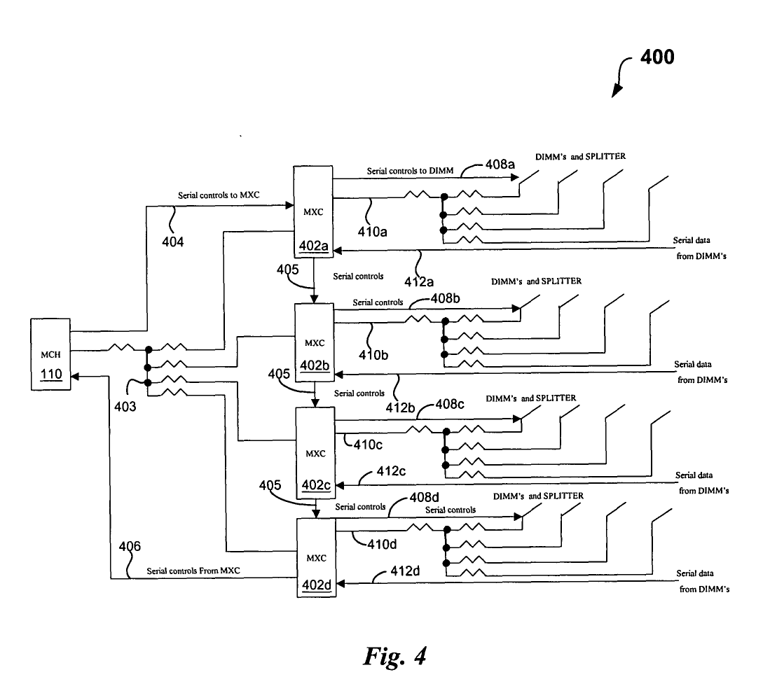

FIG. 4 illustrates an exemplary one-deep memory expander chip interconnect configuration 400 in accordance with an embodiment of the present invention. The configuration 500 includes the MCH 110, which is coupled to one or more memory expander chips (MXCs 402a-d) (e.g., through a bus splitter 403). The MCH 110 sends configuration serial controls signals (404) to the first MXC 402a, which are then forwarded to other MXCs (402b-d). In turn, the last MXC in the chain (402d) sends configuration serial controls back to the MCH 110 (406). Each MXC provides configuration serial controls (408a-d) to its DIMM and receives data signals (410a-d) and serial data (412a-d) from its DIMM.

In an embodiment of the present invention, to sufficiently support large memory structures, the MXC would incorporate the qualities needed to support an n-way topology. The data rate between the memory controller and the MXC may run at a relatively much higher bandwidth than that of directly supported DIMMs. The Memory Expander Chip may also have a built in bi-directional cache. This is envisioned to decrease latency and increase throughput efficiency. Other possible features would include, but are not limited to: local refresh generation, dynamic address space re-mapping, access re-ordering, access coalescing, memory power-on self-test (POST), local memory search engines, dynamic fault control, split and deferred transactions, and local management of open pages. Local memory search engines and/or dynamic fault control are envisioned to be valuable when supporting relatively vast memory arrays.

In a further embodiment of the present invention, utilization of bus splitters allows a frequency independent bus that combined with the MXC can support relatively large memory arrays to provide a comprehensive scalable memory solution. It is envisioned that the bus splitters discussed herein may be miniature resistive splitters on the PCB or miniature integrated resistor packs. It is envisioned that various embodiments of the present invention enable 1 GHz or higher interface with 8 GB or more memory sizes. It is also envisioned that greater than 8 GB per channel memory sizes at 1 GHz may be achieved by extending signal integrity through MXC configurations. It is envisioned that such techniques may scale with new memory technologies and can be extended to the limit of the PCB capability.

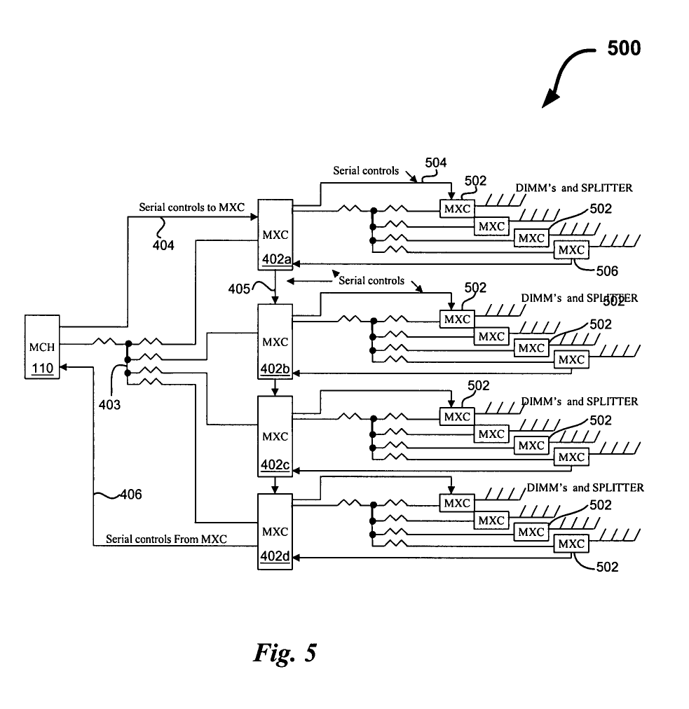

FIG. 5 illustrates an exemplary two-deep memory expander chip interconnect configuration 500 in accordance with an embodiment of the present invention. The configuration 500 further illustrates utilization of a second level of MXCs (502). The first secondary MXC receives serial controls from the primary MXC (504) and the last secondary MXC provides serial controls back to the primary MXC (506). It is envisioned that additional layers of MXCs may be utilized to support relatively much larger memory arrays.

In an embodiment of the present invention, the MXC may include a micro-controller to allow the host CPU to delegate memory intensive tasks to the MXC with direct access to the memory module (or DIMM). In a further embodiment of the present invention, for larger memories additional control, address, and clock lines may be added into a set of spare memories. This is envisioned to allow the MXC to isolate the failing chip and/or map the spare memory to those addresses and data lines which will increase the reliability significantly. This solution also may permit bypassing of other timing constraints such as those imposed by RAS and CAS.

In another embodiment of the present invention, a splitter arrangement allows all branches to the DIMM modules to be independent, from a signal quality standpoint, and still be parallel in operation. This implementation invites all signal paths be of uniform impedance. The energy transferred into the individual DIMM lines would be 1/n times the input energy for an n-way split. This may manifest itself as a decrease in signal amplitude. For example, a four-way splitter would have only one fourth of the signal amplitude at the DIMM, and would require increased sensitivity to support the decrease in amplitude. The DIMM receiving buffers may compensate for this through, for example, increased sensitivity and/or on-die termination. In a further embodiment of the present invention, the function is similar for DIMM buffers driving to the chipset.

Whereas many alterations and modifications of the present invention will no doubt become apparent to a person of ordinary skill in the art after having read the foregoing description, it is to be understood that any particular embodiment shown and described by way of illustration is in no way intended to be considered limiting. For example, the techniques described herein may be equally beneficial on the front side bus and on the hub link busses to increase bus connections to other processes and/or to increase bandwidth/reliability of operation. Therefore, references to details of various embodiments are not intended to limit the scope of the claims which in themselves recite only those features regarded as essential to the invention.

What is claimed is:

1. A circuit comprising:
a plurality of memory modules;
a memory controller coupled to the plurality of memory modules;
a plurality of bus splitters coupled between the plurality of memory modules and the memory controller to split signals communicated between the plurality of memory modules and the memory controller; and
a plurality of terminators to reduce signal reflections corresponding to the split signals.

2. The circuit of claim 1 wherein the plurality of terminators are embedded in each of the plurality of memory modules.

3. The circuit of claim 1 wherein the plurality of terminators are embedded in the memory controller.

4. The circuit of claim 1 wherein the memory modules are dual in-line memory modules (DIMMs).

5. The circuit of claim 1 further including a reference voltage generator to generate a reference voltage corresponding to a memory chip voltage.

6. The circuit of claim 5 wherein the reference voltage is provided to the plurality of memory modules and the memory controller.

7. The circuit of claim 1 wherein the plurality of bus splitters are one or more items selected from a group comprising miniature resistive splitters on a PCB and miniature integrated resistor packs.

8. The circuit of claim 1 further including a plurality of memory expander chips (MXCs) coupled between the memory controller and the plurality of memory modules.

9. The circuit of claim 8 wherein the plurality of MXCs enable access to relative larger memory arrays.

10. The circuit of claim 8 wherein each of the plurality of MXCs include one or more items selected from a list comprising a micro-controller to perform tasks locally and a built in bi-directional cache to decrease latency and increase throughput efficiency.

11. The circuit of claim 8 wherein a data rate between the memory controller and the plurality of MXCs runs at a relatively higher bandwidth than that of directly supported DIMMs.

12. The circuit of claim 8 wherein each of the plurality of MXCs include functionality selected from a group comprising local refresh generation, dynamic address space re-mapping, access re-ordering, access coalescing, memory power-on self-test (POST), and local management of open pages.

13. The circuit of claim 8 wherein a portion of the plurality of MXCs are coupled to each other in series.

14. A method comprising:
providing a plurality of memory modules;
coupling a memory controller to the plurality of memory modules;
coupling a plurality of bus splitters between the plurality of memory modules and the memory controller to split signals communicated between the plurality of memory modules and the memory controller; and
providing a plurality of terminators to reduce signal reflections corresponding to the split signals.

15. The method of claim 14 wherein the plurality of terminators are embedded in each of the plurality of memory modules.

16. The method of claim 14 wherein the plurality of terminators are embedded in the memory controller.

17. The method of claim 14 wherein the memory modules are dual in-line memory modules (DIMMs).

18. The method of claim 14 further including generating a reference voltage corresponding to a memory chip voltage.

19. The method of claim 18 wherein the reference voltage is provided to the plurality of memory modules and the memory controller.

20. The method of claim 14 wherein the plurality of bus splitters are one or more items selected from a group comprising miniature resistive splitters on a PCB and miniature integrated resistor packs.

21. The method of claim 14 further including coupling a plurality of memory expander chips (MXCs) between the memory controller and the plurality of memory modules.

22. The method of claim 21 wherein the plurality of MXCs enable access to relatively larger memory arrays.

23. The method of claim 21 wherein each of the plurality of MXCs include one or more items selected from a list comprising a micro-controller to perform tasks locally and a built in bi-directional cache to decrease latency and increase throughput efficiency.

24. The method of claim 21 wherein a data rate between the memory controller and the plurality of MXCs runs at a relatively higher bandwidth than that of directly supported DIMMs.

25. The method of claim 21 wherein each of the plurality of MXCs include functionality selected from a group comprising local refresh generation, dynamic address space re-mapping, access re-ordering, access coalescing, memory power-on self-test (POST), and local management of open pages.

26. The method of claim 21 wherein a portion of the plurality of MXCs are coupled to each other in series.

27. A computer system comprising:
a central processing unit (CPU);
a display device coupled to the CPU to display an image;
a plurality of memory modules;
a memory controller coupled to the plurality of memory modules and the CPU;
a plurality of bus splitters coupled between the plurality of memory modules and the memory controller to split signals communicated between the plurality of memory modules and the memory controller; and
a plurality of terminators to reduce signal reflections corresponding to the split signals.

28. The computer system of claim 27 further including a main memory coupled to the CPU.

29. The computer system of claim 27 further including a memory coupled to the display device to store the image.

30. The computer system of claim 27 wherein the memory controller is coupled to the CPU through a memory control hub.
